(19) United States
(12) Patent Application Publication
(10) Pub. No.: US 2020/0034484 A1
(43) Pub. Date: Jan. 30, 2020

(54) USER-DEFINED ANALYSIS OF DISTRIBUTED METADATA

(71) Applicant: Nutanix, Inc., San Jose, CA (US)

(72) Inventors: Varun Kumar ARORA, Santa Clara, CA (US); Vinayak Hindurao KHOT, Sunnyvale, CA (US)

(73) Assignee: Nutanix, Inc., San Jose, CA (US)

(21) Appl. No.: 15/365,662

(22) Filed: Nov. 30, 2016

(51) Int. Cl. G06F 17/30

(52) U.S. Cl. CPC G06F 17/30864; G06F 17/30283

(57) ABSTRACT

Systems for ad-hoc analysis of metadata in distributed data storage systems. A distributed storage system comprises computing nodes and a storage pool that is accessible by computing nodes. The storage pool comprises stored information and respective metadata that describes the stored information. Instances of a metadata search engine are installed on the computing nodes such that the metadata search engines have access to both local data stored in the storage pool as well as to networked storage in the storage pool. A user defines metadata management application extensions for extending the metadata search engine using computer programming languages. When executed by the metadata search engine, the extensions perform user-defined functions. A metadata analysis command is associated with the user-defined function and the metadata analysis command is launched from within the metadata search engine to perform the user-defined function over metadata stored in the system. Some user-defined commands include map-reduce implementations.

### FIELD

This disclosure relates to distributed data storage, and more particularly to techniques for on-demand user-defined analysis of metadata in distributed storage platforms.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

Modern computing systems (e.g., clusters combining networking facilities, computing facilities, and storage facilities) have evolved in such a way that incremental linear scaling can be accomplished in any dimension. Certain clusters in a distributed system might support over one hundred nodes that in turn support as many as several thousands (or more) of autonomous VMs. The topology and/or the storage I/O activity of the distributed system can be highly dynamic. Providers of such large scale, highly dynamic distributed systems have implemented various techniques for managing and/or analyzing the distributed systems. Some techniques use metadata associated with various aspects of the distributed system to provide insight as to the state, operational characteristics, and/or performance characteristics of the system. For example, metadata can be implemented to describe the relationships between the logical and/or physical entities or storage objects comprising the storage pool to facilitate access to and/or efficient distribution of stored data. As another example, metadata itself can be stored as storage objects which in turn can be used to describe certain characteristics pertaining to the nodes in the distributed system such as the node topology or node health. In some cases, a user might desire to access (e.g., query, search, filter, etc.) the metadata in the distributed system to perform analyses defined by that particular user.

Unfortunately, legacy approaches merely provide a fixed set of commands for accessing the metadata. In such cases, the user is limited to the metes and bounds of the fixed set of commands, which commands might not bring to bear the analysis and/or presentation that is desired by the user. A distributed system provider might provide a command-line interface (CLI) to issue the commands, however, CLIs by their nature are limited as pertaining to capturing (e.g., in text) and implementing conditional logic that might be needed to define a metadata query. In some cases, a distributed system provider can offer new “built-in” metadata access capabilities (e.g., as a new feature), however delivery of such a response to the user is always delayed for at least the time it takes to implement the new feature, then release and deploy the new feature to the field in an upgrade cycle. In such cases, the user may experience a period of poor system performance and/or other negative effects due to the absence of the specialized metadata access that might be needed to diagnose root causes (e.g., by analyzing metadata). A faster way to access and analyze metadata is needed. More specifically, techniques are needed that support scenarios where one occurrence of a user-defined metadata command or query (e.g., with a user-defined metadata analysis capability) operates differently than the metadata commands or queries that are delivered as built-in metadata analysis capabilities.

Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for on-demand user-defined analysis of metadata in distributed storage platforms, which techniques advance the relevant technologies to address technological issues with legacy approaches. More specifically, the present disclosure provides a detailed description of techniques used in systems, methods, and in computer program products for on-demand user-defined analysis of metadata in distributed storage platforms. Certain embodiments are directed to technological solutions for implementing extensions to metadata analysis applications that accept user-defined search and/or analysis capabilities so as to facilitate on-demand analyses of distributed metadata in distributed storage systems.

The disclosed embodiments modify and improve over legacy approaches. In particular, the herein-disclosed techniques provide technical solutions that address the technical problems attendant to performing user-defined analyses of metadata in highly dynamic distributed storage systems. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field pertaining to user interaction with high-performance computing platforms as well as advances in various technical fields related to data storage.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A1 and FIG. 1A2 present a flow and system for defining and using user-defined executable metadata analysis extensions to provide on-demand user-defined analysis of metadata in distributed storage platforms, according to an embodiment.

FIG. 1B depicts integration techniques as implemented in systems that support on-demand user-defined analysis of metadata in distributed storage platforms, according to an embodiment.

FIG. 2 presents a hyperconverged distributed system environment in which embodiments of the present disclosure can operate.

FIG. 3 depicts a filter result map-reduce technique as implemented in systems for on-demand user-defined analysis of metadata in distributed storage platforms, according to an embodiment.

FIG. 4 presents a metadata analysis workflow as implemented in systems for on-demand user-defined analysis of metadata in distributed storage platforms, according to some embodiments.

FIG. 5A depicts a functional interface for delivering user-defined extensions to a metadata search engine in distributed storage platforms, according to an embodiment.

FIG. 5B depicts a user interface for controlling user-defined analysis of metadata in distributed storage platforms, according to an embodiment.

FIG. 6 depicts system components as arrangements of computing modules that are interconnected so as to implement certain of the herein-disclosed embodiments.

FIG. 7A and FIG. 7B depict virtualized controller architectures comprising collections of interconnected components suitable for implementing embodiments of the present disclosure and/or for use in the herein-described environments.

### DETAILED DESCRIPTION

Some embodiments of the present disclosure address the problem of performing user-defined analyses of metadata in highly dynamic distributed storage systems and some embodiments are directed to approaches for implementing an executable metadata analysis extension infrastructure that accepts user-defined executable metadata analysis extensions to facilitate on-demand analyses of distributed metadata in distributed storage systems. The accompanying figures and discussions herein present example environments, systems, methods, and computer program products for on-demand user-defined analysis of metadata in distributed storage platforms.

### Overview

Disclosed herein are techniques for implementing an executable metadata analysis extension infrastructure that accepts user-defined executable metadata analysis extensions to facilitate on-demand analyses of distributed metadata in distributed storage systems. In certain embodiments, one or more instances of metadata analysis applications access a metadata search engine that executes within a distributed computing system. The metadata search engine can receive a command for performing an on-demand analysis according to the user-defined metadata analysis extensions. The received command can specify the subject metadata, a user-defined search filter, search filter arguments, and/or other parameters. One or more mapping functions (e.g., a mapping function based on a key derived from a subject metadata type or subject metadata identifier) in the distributed system can be invoked to collect the subject metadata. The key-value pairs of interest or other data derived from the subject metadata can then be mapped by the user-defined filter to determine a list of filtered metadata satisfying the search filter. In some embodiments, results derived from the filtered metadata can be presented to the user. In other embodiments, multiple filtered metadata lists processed across the distributed system can be reduced according to a user-defined reduce function to a result list. In some embodiments, retrieved metadata can be manipulated, modified, and written back to the metadata store from which it was retrieved.

The foregoing mapping functions are merely examples. Some embodiments include mapping to particular portions or aspects of the distributed metadata based on a key or keys derived from other metadata and/or respective characteristics (e.g., key-value pairs derived from the other metadata). In some cases, the mapping can include mapping to further functions that are used to identify metadata that satisfies a given search filter that is specific to a particular key or value or format found in the metadata.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

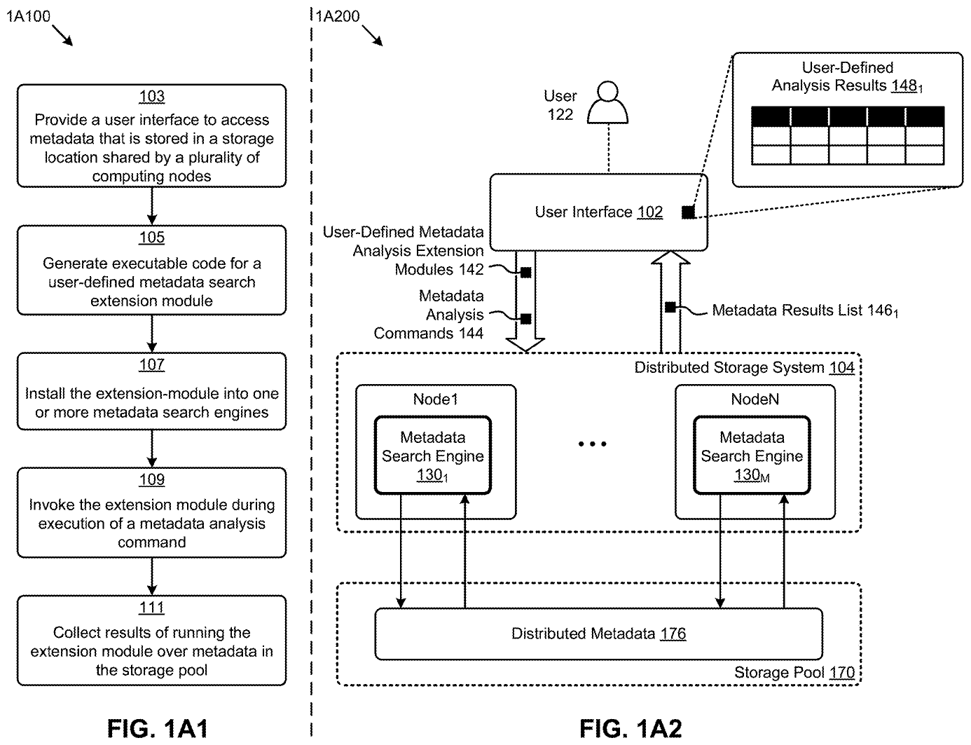

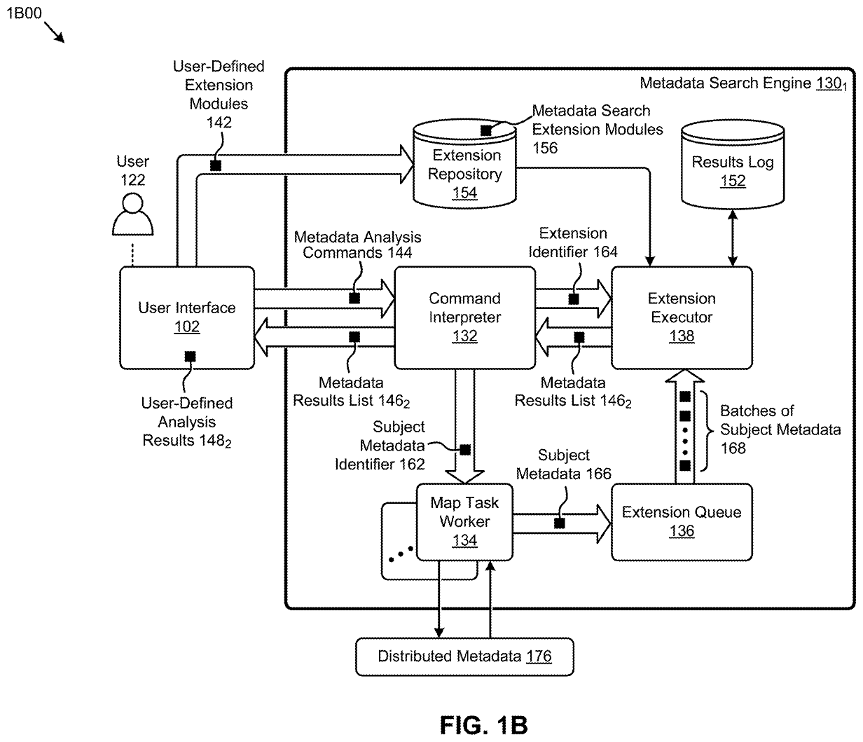

FIG. 1A1 and FIG. 1A2 present a flow and system for defining and using user-defined executable metadata analysis extensions to provide on-demand user-defined analysis of metadata in distributed storage platforms.

FIG. 1A1 presents a flow 1A100 to implement a user-defined executable metadata analysis extension to facilitate on-demand user-defined analysis of metadata in distributed storage platforms. As shown, the flow commences by providing a user interface to access metadata that is stored in a storage location shared by a plurality of computing nodes (step 103). Such a storage location shared by a plurality of computing nodes can be implemented as a storage pool that hosts multiple storage devices that are accessible by any of the plurality of computing nodes. In various embodiments, a storage pool is a storage area or repository that is populated with any combination of node-local storage devices (e.g., hard disk drives (HDDs) or solid state drives (SSDs)), multiple-access shared storage (e.g., network-attached storage (NAS), or storage area networks (SANs)). Such a storage pool can be accessed by any node over any networking or direct-attached fabric or protocol. Any node can store metadata into the storage pool at any moment in time, and in any syntax having any semantics. Predefined metadata search engines can be hosted by a node, and the predefined metadata search engine can be invoked at any moment in time (e.g., under command of a user, or under command of a supervisor program, etc.). Any invocation can be initiated with or without an extension being installed in the metadata engine.

The flow 1A100 continues upon generation of code (e.g., manual code generation and/or automatic code generation). The generated code is executable code that can be formatted as a user-defined metadata analysis extension module (step 105). A metadata analysis extension module is a collection of software instructions that are formatted to conform to a predefined calling structure. Such a module may have multiple entry points, for example an entry point for initialization, an entry point for nominal execution, and an entry point for cleanup and/or release. When a collection of software instructions is so prepared, it can be installed as an analysis extension module into one or more metadata search engines (step 107). Once installed, the code of the extension module can be invoked during execution of a metadata analysis command (step 109). Metadata commands are operations performed over metadata found in the storage pool. The running metadata commands over metadata found in the storage pool can be accomplished over multiple phases. Strictly as an example, the phases might include: (1) a phase for collecting results responsive to running the analysis extension module over metadata in the storage pool (step 111), a phase for performing some analysis (e.g., a map-reduce analysis) over the collected data, and (3) a phase for displaying outputs or determinations of the analysis.

The flow of FIG. 1A1 can be implemented in many systems and/or environments and/or in accordance with many use models, an example of which is presented in FIG. 1A2.

FIG. 1A2 presents a user-defined executable metadata analysis extension use model 1A200 as implemented in systems that support on-demand user-defined analysis of metadata in distributed storage platforms. As an option, one or more variations of user-defined executable metadata analysis extension use model 1A200 or any aspect thereof may be implemented in the context of the architecture and functionality of the embodiments described herein. The user-defined executable metadata analysis extension use model 1A200 or any aspect thereof may be implemented in any environment.

The user-defined executable metadata analysis extension use model 1A200 shown in FIG. 1A2 presents a distributed storage system 104 that uses a set of distributed metadata 176 in a storage pool 170 for managing and/or analyzing the distributed storage system 104. Distributed metadata 176 can be distributed throughout the storage pool 170 to provide insight as to the state, operational characteristics, and/or performance characteristics of distributed storage system 104. In large scale, highly dynamic distributed storage systems, the metadata is managed such that it can be strictly consistent, scalable, and highly accessible. One technique for facilitating such metadata performance characteristics distributes the metadata among portions of the storage pool associated with various nodes in a cluster. Specifically, for example, such distributed metadata (e.g., distributed metadata 176) can be replicated as key-value stores in storage pool 170 in a logical “ring” of nodes in the cluster to facilitate metadata availability and/or redundancy.

To observe the insight that can be provided by distributed metadata 176, a user 122 may desire to perform a user-defined metadata analysis. The herein disclosed techniques can facilitate such user-defined analyses by receiving at distributed storage system 104 from a user interface 102 a set of user-defined metadata analysis extension modules 142. The analysis extension modules, for example, might comprise programming code to perform a certain user-defined function such as a filter function, a reduce function, and/or other functions. User 122 can further issue from user interface 102 a set of metadata analysis commands 144 that identify one or more of the user-defined metadata analysis extension modules 142 and/or a set of subject metadata from distributed metadata 176. A metadata analysis command is any command that can be received and processed by a metadata search engine. In some embodiments, a metadata analysis command is a text string that can be entered in a command line interpreter. A metadata analysis command serves to provide an operation (e.g., a function) and a set of arguments to one or more metadata search engines. A metadata analysis command serves to operate over specific subject metadata that is identified by a name or a position or other identifier. The operation of a metadata analysis command can include the operation or function of an analysis extension module.

In this and other embodiments, one or more instances of a metadata search engine (e.g., metadata search engine 130₁, . . . , metadata search engine 130_{M}) operating at distributed storage system 104 can execute the identified analysis extension module on the subject metadata to return a metadata results list 146₁ to user interface 102. User-defined analysis results 148₁ derived from metadata results list 146₁ can be presented (e.g., displayed) by user interface 102 to provide the insight desired by user 122. The heretofore-described capabilities that support identification of, installation of, and execution of a user-defined metadata analysis extension module thus server to avoid delays incurred during the time it takes to implement a new or additional capability (e.g., feature, measurement tool, analysis tool, etc.) and then the release and deploy the new or additional capability in an upgrade cycle.

Further details of one embodiment of the metadata search engine are shown and described as pertaining to FIG. 1B.

FIG. 1B depicts integration techniques 1B00 as implemented in systems that support on-demand user-defined analysis of metadata in distributed storage platforms. As an option, one or more variations of integration techniques 1B00 or any aspect thereof may be implemented in the context of the architecture and functionality of the embodiments described herein. The integration techniques 1B00 or any aspect thereof may be implemented in any environment.

Depicted in FIG. 1B is a representative instance of an embodiment of the metadata search engine earlier shown and described as pertaining to FIG. 1A2. Specifically, metadata search engine 130₁ is shown interacting with user interface 102 to facilitate on-demand user-defined analysis (e.g., by user 122) of distributed metadata 176. More specifically, user-defined metadata analysis extension modules 142 are stored in an extension repository 154 accessible by metadata search engine 130₁. For example, user-defined metadata analysis extension modules 142 can be designed by user 122 and/or by a third-party (e.g., distributed storage system provider). Any language (e.g., Python, Lua, etc.) that can be embedded in the programming code environment (e.g., C++) of metadata search engine 130₁ can be used to construct the user-defined metadata analysis extension modules 142. Multiple instances of user-defined metadata analysis extension modules 142 from users, providers, and/or other sources can comprise a set of metadata search extension modules 156 stored in extension repository 154. Metadata search extension modules 156 are available to all instances of any metadata search engines (e.g., in multiple nodes in a cluster, across multiple clusters, etc.). An instance of a metadata analysis commands is received at a command interpreter 132, which command can be parsed by command interpreter 132 to determine a subject metadata identifier 162 and an extension identifier 164. The subject metadata identifier 162 is used by metadata search engine 130₁ to invoke one or more map task workers (e.g., map task worker 134) to collect a set of subject metadata 166 (e.g., metadata key-value pairs) corresponding to subject metadata identifier 162 from distributed metadata 176. For example, instances of the map task workers might correspond to a set of respective nodes in a cluster.

The collected subject metadata is staged by an extension queue 136 into batches of subject metadata 168 that are delivered to an extension executor 138. For example, the batches of subject metadata 168 might be apportioned based at least in part on a number of metadata items, a metadata size (e.g., in MB), and/or other attributes. An extension executor 138 exposes each of the batches of subject metadata 168 to one or more of the metadata search extension modules 156 designated by the extension identifier 164. The results produced by executing the identified extension module on the subject metadata is accumulated into a metadata results list 146₂ that is forwarded by command interpreter 132 to user interface 102. In some cases, extension executor 138 can store the results in a results log 152 accessible by metadata search engine 130₁ and/or user interface 102. User-defined analysis results 148₂ that was derived from any portions of the metadata results list 146₂ can be presented (e.g., displayed) to user 122 via the user interface 102.

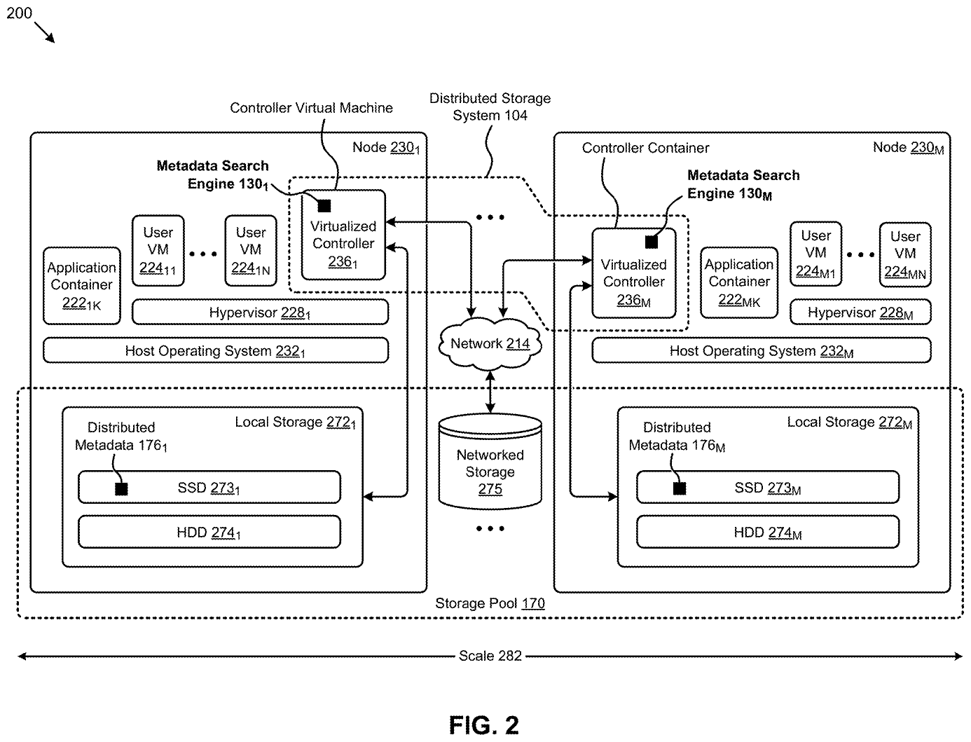

As earlier mentioned, distributed metadata 176 can be associated with a large scale, highly dynamic, hyperconverged distributed system having clusters that might support over one hundred nodes that in turn support as many as several thousands (or more) of autonomous VMs. One embodiment of an environment comprising such a hyperconverged distributed system is shown and described as pertains to FIG. 2.

FIG. 2 presents a hyperconverged distributed system environment 200 in which embodiments of the present disclosure can operate. As an option, one or more variations of environment 200 or any aspect thereof may be implemented in the context of the architecture and functionality of the embodiments described herein.

The hyperconverged distributed system environment 200 shows various components associated with one instance of a hyperconverged distributed system comprising a distributed storage system 104 that can be used to implement the herein disclosed techniques. Specifically, the hyperconverged distributed system environment 200 comprises multiple nodes (e.g., node 230₁, . . . , node 230_{M}) that have multiple tiers of storage in a storage pool 170. For example, each node can be associated with one server, multiple servers, or portions of a server. A group of such nodes can be called a cluster. As shown, the multiple tiers of storage include storage that is accessible through the network 214, such as a networked storage 275 (e.g., a storage area network or SAN, network attached storage or NAS, etc.). The multiple tiers of storage further include instances of local storage (e.g., local storage 272₁, . . . , local storage 272_{M}). For example, the local storage can be within or directly attached to a server and/or appliance associated with the nodes. Such local storage can include solid state drives (SSD 273₁, . . . , SSD 273_{M}), hard disk drives (HDD 274₁, . . . , HDD 274_{M}), and/or other storage devices. Specifically, the SSD storage might store instances of the distributed metadata (e.g., distributed metadata 176₁, . . . , distributed metadata 176_{M}).

As shown, the nodes in hyperconverged distributed system environment 200 can implement one or more user virtual machines (e.g., user VM 224₁₁, . . . , user VM 224_{1N}, . . . , user VM 224_{M1}, . . . , user VM 224_{MN}) and/or application containers (e.g., application container 222_{1K}, . . . , application container 222_{MK}). The user VMs can be characterized as software-based computing “machines” implemented in a hypervisor-assisted virtualization environment that emulates the underlying hardware resources (e.g., CPU, memory, etc.) of the nodes. For example, multiple user VMs can operate on one physical machine (e.g., node host computer) running a single host operating system (e.g., host operating system 232₁, . . . , host operating system 232_{M}), while the user VMs run multiple applications on various respective guest operating systems. Such flexibility can be facilitated at least in part by a hypervisor (e.g., hypervisor 228₁, . . . , hypervisor 228_{M}), which hypervisor is logically located between the various guest operating systems of the user VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the application containers are implemented at the nodes in an operating system virtualization or container virtualization environment. The application containers comprise groups of processes and/or resources (e.g., memory, CPU, disk, etc.) that are isolated from the node host computer and other containers. Such containers directly interface with the kernel of the host operating system with, in most cases, no hypervisor layer. This lightweight implementation can facilitate efficient distribution of certain software components such as applications or services (e.g., micro-services). As shown, hyperconverged distributed system environment 200 can implement both a hypervisor-assisted virtualization environment and a container virtualization environment for various purposes.

Hyperconverged distributed system environment 200 also comprises at least one instance of a virtualized controller to facilitate access to storage pool 170 by the user VMs and/or application containers. Multiple instances of such virtualized controllers can coordinate within a cluster to form the distributed storage system 104 which can, among other operations, manage the storage pool 170. This architecture further facilitates efficient scaling of the hyperconverged distributed system (e.g., refer to the axis of scale 282). The foregoing virtualized controllers can be implemented in hyperconverged distributed system environment 200 using various techniques. Specifically, an instance of a virtual machine at a given node can be used as a virtualized controller in a hypervisor-assisted virtualization environment to manage storage and I/O (input/output or IO) activities.

In this case, for example, the user VMs at node 230₁ can interface with a controller virtual machine (e.g., virtualized controller 236₁) through hypervisor 228₁ to access the storage pool 170. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 104. For example, a hypervisor at one node in the distributed storage system 104 might correspond to VMware ESXi software, and a hypervisor at another node in the distributed storage system 104 might correspond to Nutanix AHV software. As another virtualized controller implementation example, containers (e.g., Docker containers) can be used to implement a virtualized controller (e.g., virtualized controller 236_{M}) in an operating system virtualization environment at a given node. In this case, for example, the user VMs at node 230_{M} can access the storage pool 170 by interfacing with a controller container (e.g., virtualized controller 236_{M}) through hypervisor 228_{M} and/or the kernel of host operating system 232_{M}.

Further details regarding general approaches to managing storage pools are described in U.S. Pat. No. 8,601,473 titled, “ARCHITECTURE FOR MANAGING I/O AND STORAGE FOR A VIRTUALIZATION ENVIRONMENT” issued on Dec. 3, 2013, which is hereby incorporated by reference in its entirety.

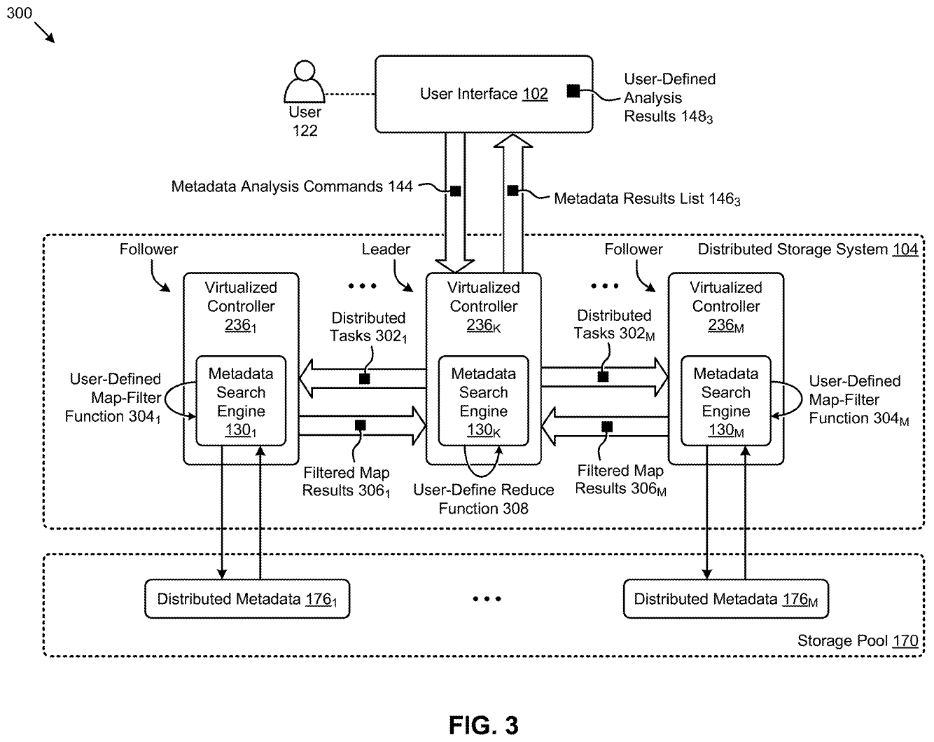

In certain embodiments, one or more instances of a metadata search engine can be implemented in the distributed storage system 104 to facilitate the herein disclosed techniques. Specifically, metadata search engine 130₁ can be implemented in the virtualized controller 236₁, and metadata search engine 130_{M} can be implemented in the virtualized controller 236_{M}. Such instances of the metadata search engine can be implemented in any node in any cluster. In some cases, multiple instances of the metadata search engine implemented in a given cluster might carry out distributed tasks corresponding to a respective set of functions to facilitate the herein disclosed techniques. One such example and embodiment is shown and described as pertaining to FIG. 3.

FIG. 3 depicts a filter result map-reduce technique 300 as implemented in systems for on-demand user-defined analysis of metadata in distributed storage platforms. As an option, one or more variations of filter result map-reduce technique 300 or any aspect thereof may be implemented in the context of the architecture and functionality of the embodiments described herein. The filter result map-reduce technique 300 or any aspect thereof may be implemented in any environment.

Filter result map-reduce technique 300 depicts components and data flows illustrating the implementation of the herein disclosed techniques in distributed storage system 104 using a map-reduce framework. In some cases, map-reduce techniques can be used with the herein disclosed techniques to improve performance (e.g., latency) of certain user-defined metadata analyses by facilitating task distribution, local data processing, and/or other performance enhancing techniques.

Further details regarding general approaches to managing and maintaining data in data repositories are described in U.S. Pat. No. 8,549,518 titled, “METHOD AND SYSTEM FOR IMPLEMENTING MAINTENANCE SERVICE FOR MANAGING I/O AND STORAGE FOR A VIRTUALIZATION ENVIRONMENT” issued on Oct. 1, 2013, which is hereby incorporated by reference in its entirety.

As shown, metadata analysis commands 144 issued by user 122 from user interface 102 are received at distributed storage system 104 by one of multiple virtualized controllers (e.g., virtualized controller 236₁, . . . , virtualized controller 236_{K}, . . . , virtualized controller 236_{M}) running a respective instance of the metadata search engine (e.g., metadata search engine 130₁, . . . , metadata search engine 130_{K}, . . . , metadata search engine 130_{M}). For example, virtualized controller 236_{K} receiving the metadata analysis commands 144 and/or other controller requests might be elected as the leader (e.g., master) of other virtualized controllers designated as followers in a cluster and/or portion of a cluster. In other cases, metadata search engine 130_{K} might be elected as the leader of other instances of the metadata search engine in the cluster. In both cases, the leader is responsible for task and job delegation among the followers.

Further details regarding general approaches to leader election in distributed storage systems are described in U.S. application Ser. No. 15/160,347 titled, “SCALABLE LEADERSHIP ELECTION IN A MULTI-PROCESSING COMPUTING ENVIRONMENT” filed on May 20, 2016, which is hereby incorporated by reference in its entirety.

As shown in FIG. 3, the metadata analysis commands 144 received at the leader (e.g., metadata search engine 130_{K}) can precipitate delegation of various distributed tasks (e.g., distributed tasks 302₁ and distributed tasks 302_{M}) to respective instances of the metadata search engine running at follower virtualized controllers. Such distributed tasks might, for example, be selected to apportion the workload pertaining to a given metadata analysis command to various nodes to facilitate parallel processing of the command. As shown, the distributed tasks might instruct the metadata search engines to concurrently perform a user-defined map and filter function (operation 304₁ and operation 304_{M}) on a respective local portion of distributed metadata (e.g., distributed metadata 176₁ and distributed metadata 176_{M}). In this case, the distributed tasks might include an input key value (e.g., k1₁ and k1_{M}) indicating the local portion of distributed metadata for processing by each metadata search engine.

For example, the input key value might be derived from a subject metadata identifier extracted from the metadata analysis command. The user-defined map and filter programming code can be executed for the input key value at each metadata search engine to generate filtered map results (e.g., filtered map results 306₁ and filtered map results 306_{M}) organized by a respective list key (e.g., k2₁ and k2_{M}). The metadata search engine 130_{K} associated with the leader can execute a user-defined reduce function (operation 308) on the filtered map results from the followers to generate the metadata results list 146₃ that can be used to present user-defined analysis results 148₃. In the case shown, metadata search engine 130_{K} can combine the output from applying the reduce function, sorted by list key, to generate the metadata results list 146₃. In some cases, the reduce function can also be distributed to multiple processing entities (e.g., the followers) by transmitting one or more of the list keys and associated results to the respective processing entities.

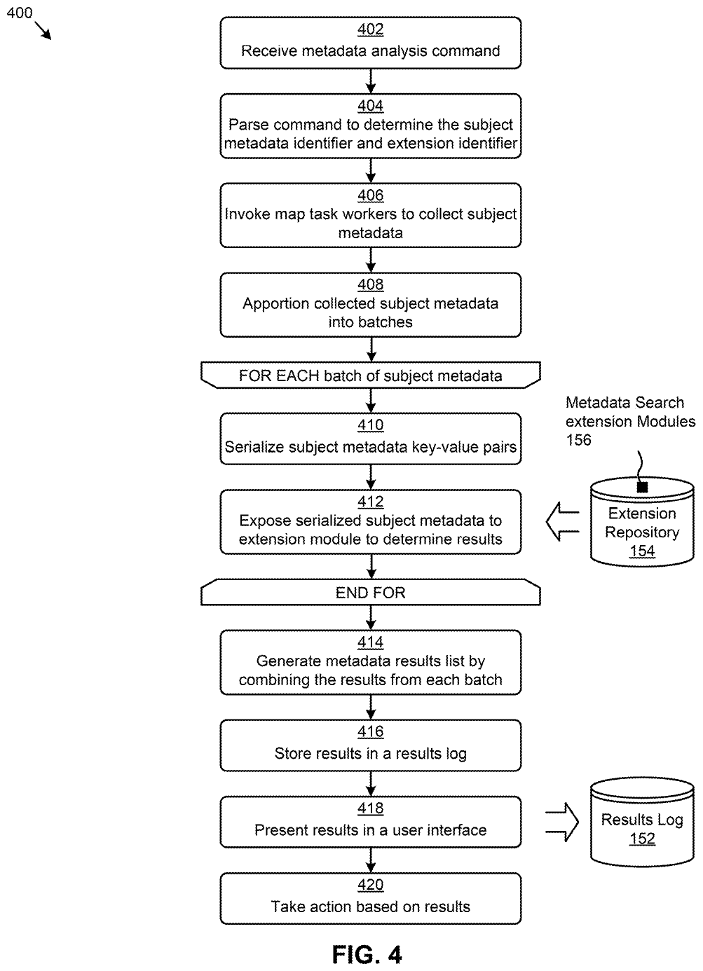

FIG. 4 presents a metadata analysis workflow 400 as implemented in systems for on-demand user-defined analysis of metadata in distributed storage platforms. As an option, one or more variations of metadata analysis workflow 400 or any aspect thereof may be implemented in the context of the architecture and functionality of the embodiments described herein. The metadata analysis workflow 400 or any aspect thereof may be implemented in any environment.

FIG. 4 presents one embodiment of certain steps and/or operations for facilitating on-demand user-defined analysis of metadata in distributed storage platforms, according to the herein disclosed techniques. In one or more embodiments, the steps and underlying operations shown in FIG. 4 can be facilitated at least in part by an instance of the metadata search engine 130₁ earlier shown and described as pertaining to FIG. 1B.

As shown, the workflow can commence with receiving a metadata analysis command (step 402). The received command is parsed to determine a subject metadata identifier (e.g., input key), an extension identifier (e.g., filter name), and/or other command arguments and/or switches (step 404). One or more map task workers are invoked to collect (e.g., map) a respective portion of the subject metadata (step 406). For example, the subject metadata (e.g., key-value pairs) can be determined from the subject metadata identifier (e.g., map key). The number and/or location (e.g., node) of the map task workers can be determined based at least in part on various task distribution techniques implemented in distributed computing and/or storage systems. In some cases, the collected subject metadata (e.g., key-value pairs) can be apportioned to multiple batches for further processing (step 408). For example, the batches might be determined based on a number of metadata items, a metadata size (e.g., in MB), and/or other attributes.

For each batch of subject metadata, the metadata key-value pairs are serialized (step 410) for exposure to one or more extension modules to determine the results (step 412). For example, extension modules from metadata search extension modules 156 in extension repository 154 that are written in Python can process serialized (e.g., “pickled”) key-value pairs. When all of the batches of subject metadata have been processed, the metadata results list is generated by combining results from each batch (step 414). For example, the results might comprise a list of key-value pairs that match a filter codified in the extension module. The combined results can be stored in a results log (e.g., results log 152) (step 416) and/or presented in a user interface (step 418). A user (e.g., system administrator, provider engineer, etc.) can take various actions based at least in part on the results in the results log and/or presented in the user interface (step 420).

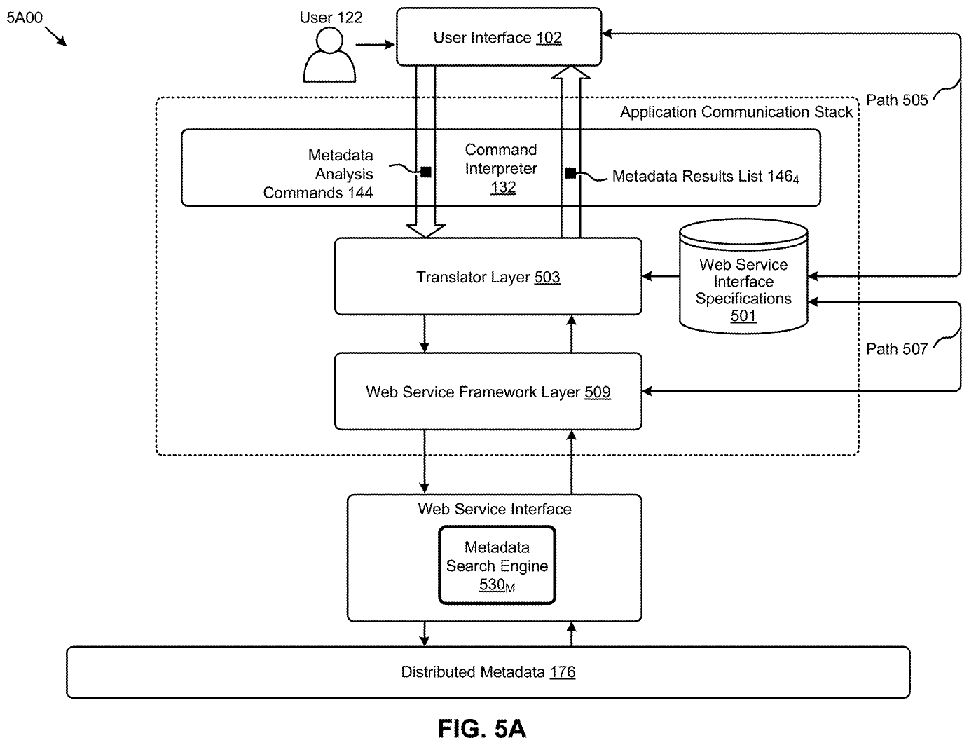

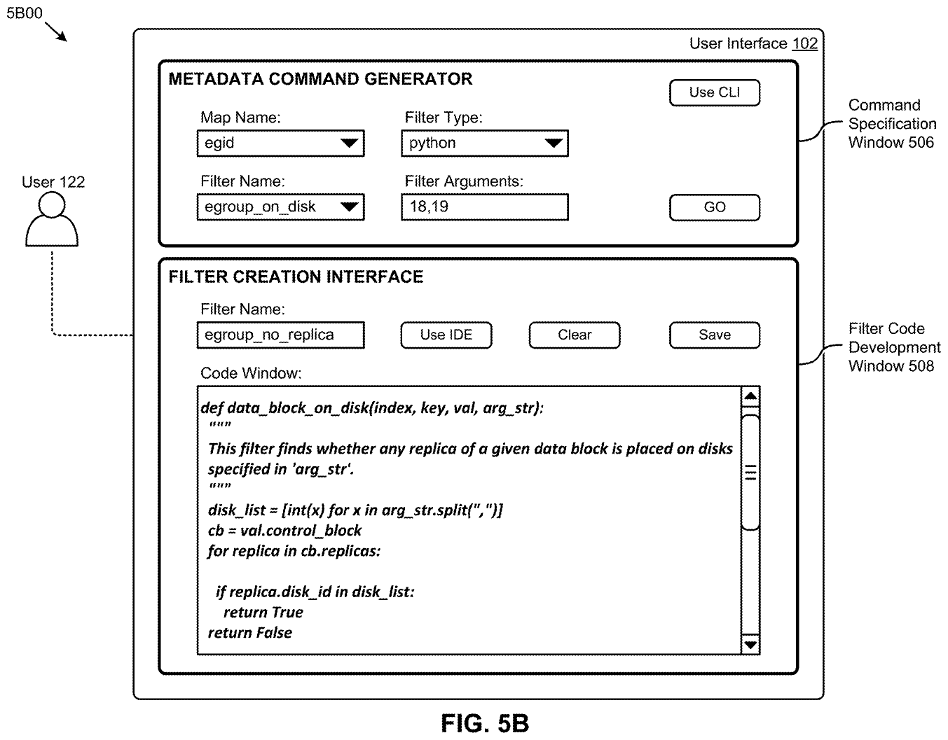

For example, a user might implement the herein disclosed techniques to discover data blocks mapped to a given extent (e.g., a portion of logically contiguous data). Such user-defined analysis can be used to identify virtual disks (e.g., vDisks) that may be affected by a filesystem bug. As another example, a user might write an extension module to discover and/or create heat maps for a particular user-defined purpose and/or in accordance with particular logic, such as identifying extents groups on an SSD that are uncompressed and have not been accessed for a certain period of time (e.g., 1 hour). In other cases, a user can write filters to perform certain tasks when a subject metadata match occurs. For example, a user can write user-defined information lifecycle management (ILM) routines. A user might also want to migrate (e.g., to another storage tier) certain extent groups identified as having no write access for greater than a certain time period (e.g., 1 hour). The foregoing combination of metadata searches being performed together with conditional actions taken based on metadata search results are facilitated by an application communication stack, as depicted in FIG. 5A.

FIG. 5A depicts a functional interface 5A00 for delivering user-defined extensions to a metadata search engine in distributed storage platforms. As shown, components within an application communication stack are situated between the user interface 102 and one or more instances of a metadata search engine (e.g., metadata search engine 530_{M}). As shown, the application communication stack is composed of a translator layer that serves as middleware between a client (e.g., a user interface, with or without a web browser) and a set of web services (e.g., services provided by the shown metadata search engine 530_{M}).

More particularly, in the specific embodiment shown, metadata analysis commands are processed by the command interpreter, and forwarded to next processing layers. The translator layer 503 receives one or more (e.g., in a stream) metadata analysis commands 144 and translates them into a format that is consumed by the web service interface, possibly after being processed and forwarded by the web service framework layer 509. The specific format into which the translator layer and/or the web service framework layer can recode commands can be codified into formal language constructs (e.g., XML, constructs) that are stored as a set of web service interface specifications 501. The contents of the web service interface specifications can be written to and/or read from via path 505 and/or via path 507. In some cases, one or more web service interface specifications can be provided by a user 122 that operates a user interface 102. The web service interface specifications can be accessed by the web service framework layer 509 so as to maintain currency, even when new web service interface specifications are provided dynamically on an ongoing basis. As such, a web service interface specification can be generated in accordance with the parameterization and/or other interfacing needs of newly-coded user-defined metadata analysis extension modules. In some embodiments, a web service interface specification can be defined to match, or to recode, or to otherwise process returned metadata results (e.g., metadata results list 146₄) as may be communicated between a metadata search engine and a command interpreter.

Any aspects of web service interface specifications and/or analysis commands and/or results specifications can be defined in conjunction with a user interface. One embodiment of such a user interface is shown and described as pertaining to FIG. 5B.

FIG. 5B depicts a user interface 5B00 for controlling user-defined analysis of metadata in distributed storage platforms. As an option, one or more variations of user interface 5B00 or any aspect thereof may be implemented in the context of the architecture and functionality of the embodiments described herein. The user interface 5B00 or any aspect thereof may be implemented in any environment.

Specifically, the user interface 5B00 shown in FIG. 5B can be used by a user (e.g., user 122) to specify certain parameters describing a metadata analysis command and/or create a user-defined metadata analysis extension module (e.g., a filter). More specifically, user interface 5B00 can comprise a command specification window 506 that can be presented to user 122 in user interface 102. As shown, the command specification window 506 can present various input entry elements (e.g., dropdown selections, text boxes, etc.) through which user 122 can specify certain parameters associated with a given metadata analysis command. For example, user 122 can specify a “Map Name” (e.g., egid) that can serve as a subject metadata identifier for the subject metadata associated with the command. The “Filter Type” (e.g., Python), “Filter Name” (e.g., egroup_on_disk), and/or “Filter Arguments” (e.g., 18, 19) can also be selected in command specification window 506.

When the command parameters are specified, the user can click “Go” to launch the command (e.g., to the leader metadata search engine). The user 122 might also use the command line interpreter (CLI) to issue the metadata analysis commands by clicking “Use CLI”. In some cases, clicking “Use CLI” brings up a pop-up (e.g., as an X-terminal pop-up) that allows a user to specify a path or other location of an extension. In still other embodiments, clicking a “Use IDE” button brings up an interface to the user's integrated design environment (IDE). Such an IDE can be preconfigured (e.g., by the user) so as to invoke a user interface of one or another selected types and/or to invoke the IDE using preconfigured defaults (e.g., a base directory location).

The user 122 can further create user-defined metadata analysis extension modules in the filter code development window 508. Specifically, for example, user 122 can specify the “Filter Name” (e.g., egroup_no_replica) and enter the programming code for the extension in the “Code Window”. As an example, pseudo-code for a filter to find extent groups with all unhealthy replicas is shown in FIG. 5B. Other filters and/or user-defined functions comprising the metadata search extension modules used by the herein disclosed techniques are possible.

In certain embodiments, such metadata search extensions serve to accept inputs corresponding to an index, a key, a value, and a set of arguments. For example, the index might correspond to a serial number of a key-value pair. The key might correspond to a parsed subject metadata identifier (e.g., vDiskID, vBlockNum, extentID, extentGroupID, enterpriseID, etc.) associated with the subject metadata map. The value might correspond to the parse value of a given subject metadata map. The set of arguments can be associated with various other inputs used by the extension module. Further, the output of the module can provide a “true” or “false” result where, for example, “true” can indicate that a certain key-value pair matches the filter, and “false” can indicate that the key-value pair does not match the filter.

### Additional Embodiments of the Disclosure

### Additional Practical Application Examples

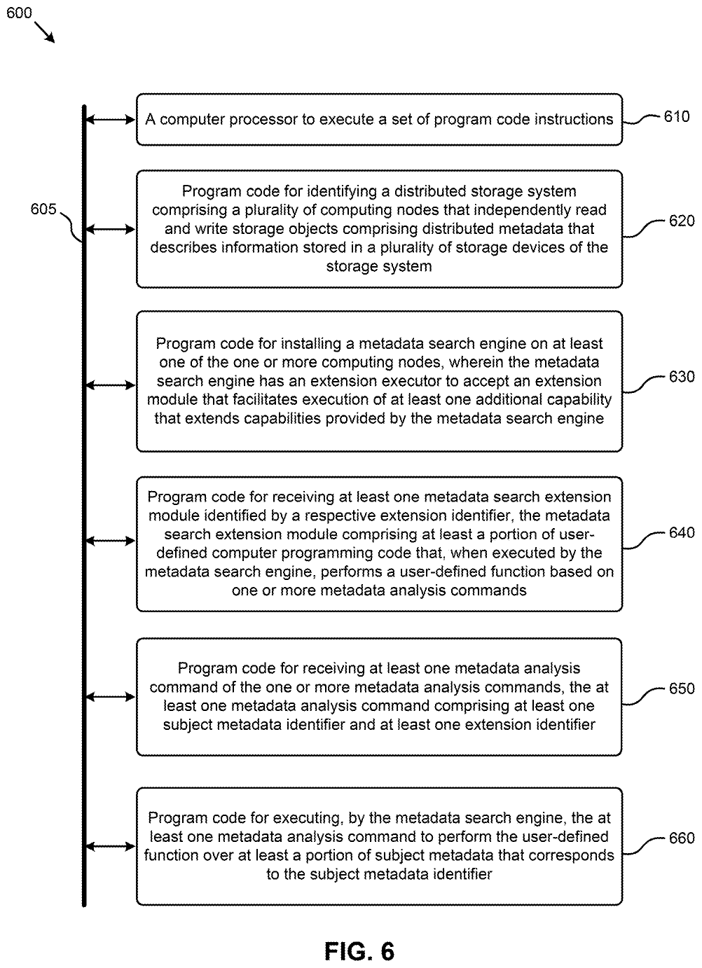

FIG. 6 depicts a system 600 as an arrangement of computing modules that are interconnected so as to operate cooperatively to implement certain of the herein-disclosed embodiments. The partitioning of system 600 is merely illustrative and other partitions are possible. As an option, the system 600 may be implemented in the context of the architecture and functionality of the embodiments described herein. Of course, however, the system 600 or any operation therein may be carried out in any desired environment. The system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims. The shown embodiment implements a portion of a computer system, presented as system 600, comprising a computer processor to execute a set of program code instructions (module 610) and modules for accessing memory to hold program code instructions to perform: identifying a distributed storage system comprising a plurality of computing nodes that independently read and write storage objects comprising distributed metadata that describes information stored in a plurality of storage devices of the storage system (module 620); installing a metadata search engine on at least one of the one or more computing nodes, wherein the metadata search engine has an extension executor to accept an extension module that facilitates execution of at least one additional capability that extends capabilities provided by the metadata search engine (module 630); receiving at least one metadata search extension module identified by a respective extension identifier, the metadata search extension module comprising at least a portion of user-defined computer programming code that, when executed by the metadata search engine, performs a user-defined function based on one or more metadata analysis commands (module 640); receiving at least one metadata analysis command of the one or more metadata analysis commands, the at least one metadata analysis command comprising at least one subject metadata identifier and at least one extension identifier (module 650); and executing, by the metadata search engine, the at least one metadata analysis command to perform the user-defined function over at least a portion of subject metadata that corresponds to the subject metadata identifier (module 660).

Variations of the foregoing may include more or fewer of the shown modules and variations may perform more or fewer (or different) steps, and/or may use data elements in more, or in fewer (or different) operations.

### System Architecture Overview

### Additional System Architecture Examples

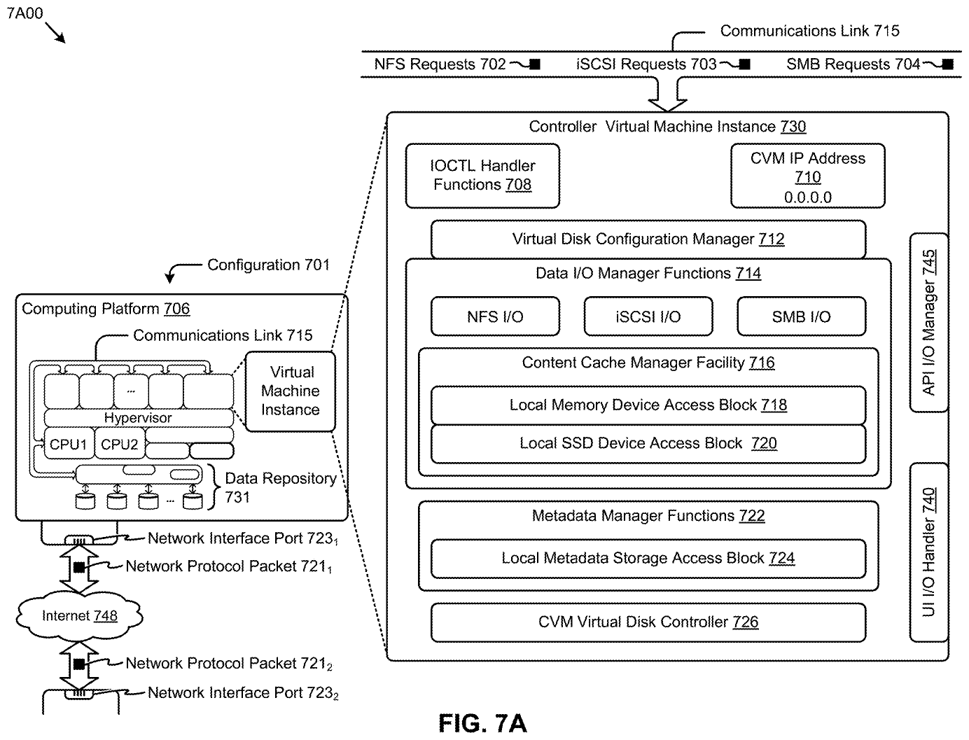

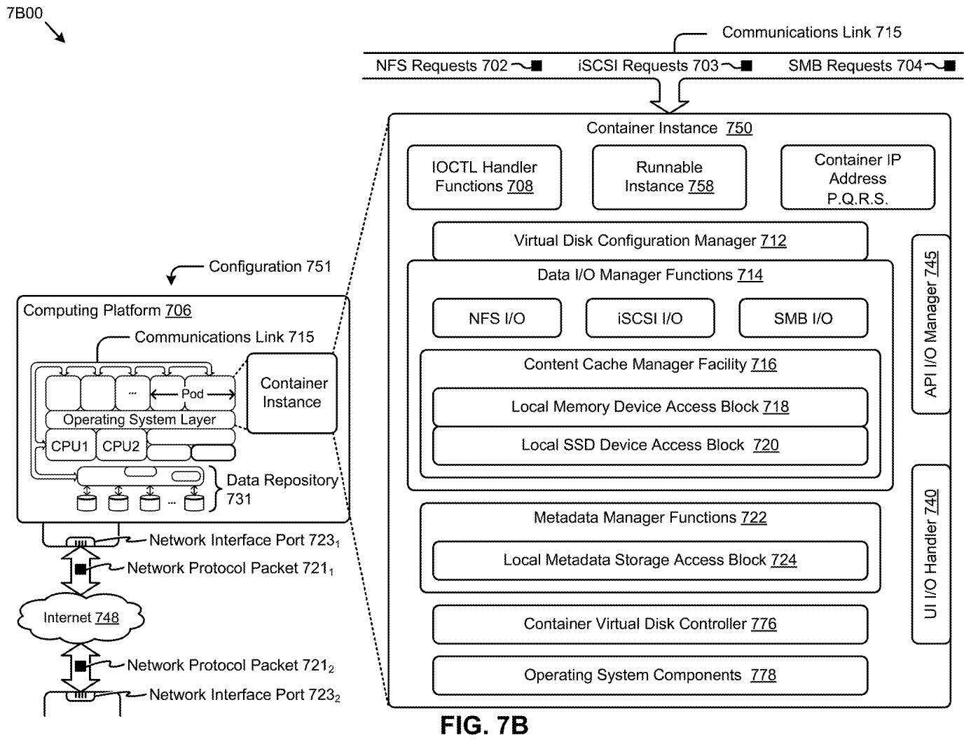

FIG. 7A depicts a virtualized controller as implemented by the shown virtual machine architecture 7A00. The heretofore-disclosed embodiments, including variations of any virtualized controllers, can be implemented in distributed systems where a plurality of networked connected devices can communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively so as to serve a particular objective, such as to provide high-performance computing, high-performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates efficient use of compute and storage resources by and between the components of the distributed system. Adding a hyperconverged unit to a hyperconverged system expands the system in multiple dimensions. As an example, adding a hyperconverged unit to a hyperconverged system can expand in the dimension of storage capacity while concurrently expanding in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

The virtual machine architecture 7A00 comprises a collection of interconnected components suitable for implementing embodiments of the present disclosure and/or for use in the herein-described environments. Moreover, the shown virtual machine architecture 7A00 includes a virtual machine instance in a configuration 701 that is further described as pertaining to the controller virtual machine instance 730. A controller virtual machine instance receives block I/O (input/output or IO) storage requests as network file system (NFS) requests in the form of NFS requests 702, and/or internet small computer storage interface (iSCSI) block IO requests in the form of iSCSI requests 703, and/or Samba file system (SMB) requests in the form of SMB requests 704. The controller virtual machine (CVM) instance publishes and responds to an internet protocol (IP) address (e.g., see CVM IP address 710). Various forms of input and output (I/O or IO) can be handled by one or more IO control handler functions (see IOCTL functions 708) that interface to other functions such as data IO manager functions 714 and/or metadata manager functions 722. As shown, the data IO manager functions can include communication with a virtual disk configuration manager 712 and/or can include direct or indirect communication with any of various block IO functions (e.g., NFS TO, iSCSI TO, SMB TO, etc.).

In addition to block IO functions, the configuration 701 supports IO of any form (e.g., block TO, streaming TO, packet-based TO, HTTP traffic, etc.) through either or both of a user interface (UI) handler such as UI IO handler 740 and/or through any of a range of application programming interfaces (APIs), possibly through the shown API IO manager 745.

The communications link 715 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 730 includes a content cache manager facility 716 that accesses storage locations, possibly including local dynamic random access memory (DRAM) (e.g., through the local memory device access block 718) and/or possibly including accesses to local solid state storage (e.g., through local SSD device access block 720).

Common forms of computer readable media includes any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 731, which in turn can be formatted into any one or more storage areas, and which can comprise parameterized storage accessible by a key (e.g., a filename, a table name, a block address, an offset address, etc.). An external data repository 731 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 724. The external data repository 731 can be configured using a CVM virtual disk controller 726, which can in turn manage any number or any configuration of virtual disks.

Execution of the sequences of instructions to practice certain embodiments of the disclosure are performed by a one or more instances of a processing element such as a data processor, or such as a central processing unit (e.g., CPU1, CPU2). According to certain embodiments of the disclosure, two or more instances of a configuration 701 can be coupled by a communications link 715 (e.g., backplane, LAN, PSTN, wired or wireless network, etc.) and each instance may perform respective portions of sequences of instructions as may be required to practice embodiments of the disclosure.

The shown computing platform 706 is interconnected to the Internet 748 through one or more network interface ports (e.g., network interface port 723₁ and network interface port 723₂). The configuration 701 can be addressed through one or more network interface ports using an IP address. Any operational element within computing platform 706 can perform sending and receiving operations using any of a range of network protocols, possibly including network protocols that send and receive packets (e.g., network protocol packet 721₁ and network protocol packet 721₂).

The computing platform 706 may transmit and receive messages that can be composed of configuration data, and/or any other forms of data and/or instructions organized into a data structure (e.g., communications packets). In some cases, the data structure includes program code instructions (e.g., application code) communicated through Internet 748 and/or through any one or more instances of communications link 715. Received program code may be processed and/or executed by a CPU as it is received and/or program code may be stored in any volatile or non-volatile storage for later execution. Program code can be transmitted via an upload (e.g., an upload from an access device over the Internet 748 to computing platform 706). Further, program code and/or results of executing program code can be delivered to a particular user via a download (e.g., a download from the computing platform 706 over the Internet 748 to an access device).

The configuration 701 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor. Some embodiments include one or more special-purpose hardware components (e.g., power control, logic, sensors, transducers, etc.). A module may include one or more state machines and/or combinational logic used to implement or facilitate the operational and/or performance characteristics pertaining to implementation of on-demand user-defined analysis of metadata in distributed storage platforms.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects pertaining to implementation of on-demand user-defined analysis of metadata in distributed storage platforms). Such files or records can be brought into and/or stored in volatile or non-volatile memory.

FIG. 7B depicts a virtualized controller implemented by a containerized architecture 7B00. The containerized architecture comprises a collection of interconnected components suitable for implementing embodiments of the present disclosure and/or for use in the herein-described environments. Moreover, the shown containerized architecture 7B00 includes a container instance in a configuration 751 that is further described as pertaining to the container instance 750. The configuration 751 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 750). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system, and can be configured to be accessed by file system commands (e.g., “ls” or “ls−a”, etc.). The container might optionally include operating system components 778, however such a separate set of operating system components need not be provided. As an alternative, a container can include a runnable instance 758, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 776. Such a container virtual disk controller can perform any of the functions that the aforementioned CVM virtual disk controller 726 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
identifying a distributed storage system comprising a plurality of computing nodes that independently read and write storage objects comprising distributed metadata that describes information stored in a plurality of storage devices of the storage system;
installing a metadata search engine on at least one of the one or more computing nodes, wherein the metadata search engine has an extension executor to accept an extension module that facilitates execution of at least one additional capability that extends capabilities provided by the metadata search engine;
receiving at least one metadata search extension module identified by a respective extension identifier, the metadata search extension module comprising at least a portion of user-defined computer programming code that, when executed by the metadata search engine, performs a user-defined function based on one or more metadata analysis commands;
receiving at least one metadata analysis command of the one or more metadata analysis commands, the at least one metadata analysis command comprising at least one subject metadata identifier and at least one extension identifier; and
executing, by the metadata search engine, the at least one metadata analysis command to perform the user-defined function over at least a portion of subject metadata that corresponds to the subject metadata identifier.

2. The method of claim 1, further comprising:
collecting multiple instances of the subject metadata from metadata stored in a storage pool; and
generating a metadata results list derived from the subject metadata.

3. The method of claim 2, wherein accessing the subject metadata comprises apportioning the subject metadata into one or more batches accessible by respective computing nodes.

4. The method of claim 3, wherein the batches are apportioned based at least in part on at least one of, a number of metadata items, or a metadata size.

5. The method of claim 2, wherein generating the metadata results list comprises reducing two or more sets of the subject metadata based at least in part on a second user-defined function corresponding to a second metadata search extension module.

6. The method of claim 5, wherein the second user-defined function is a reduce function.

7. The method of claim 2, wherein the metadata search engine has access to at least some portion networked storage in the storage pool.

8. The method of claim 1, wherein the user-defined function comprises a filter function, or a map task, or a reduce function.

9. The method of claim 1, wherein accessing the subject metadata by the metadata search extension module comprises serializing the subject metadata to be ingested by the metadata search extension module.

10. The method of claim 1, wherein collecting the subject metadata comprises mapping the distributed metadata to the subject metadata based at least in part on a key derived from the subject metadata identifier.

11. The method of claim 1, further comprising presenting a set of user-defined analysis results in a user interface.

12. The method of claim 1, wherein the at least one additional capability comprises an ability to process a query.

13. A computer readable medium, embodied in a non-transitory computer readable medium, the non-transitory computer readable medium having stored thereon a sequence of instructions which, when stored in memory and executed by one or more processors causes the one or more processors to perform a set of acts the acts comprising:
identifying a distributed storage system comprising a plurality of computing nodes that independently read and write storage objects comprising distributed metadata that describes information stored in a plurality of storage devices of the storage system;
installing a metadata search engine on at least one of the one or more computing nodes, wherein the metadata search engine has an extension executor to accept an extension module that facilitates execution of at least one additional capability that extends capabilities provided by the metadata search engine;
receiving at least one metadata search extension module identified by a respective extension identifier, the metadata search extension module comprising at least a portion of user-defined computer programming code that, when executed by the metadata search engine, performs a user-defined function based on one or more metadata analysis commands;
receiving at least one metadata analysis command of the one or more metadata analysis commands, the at least one metadata analysis command comprising at least one subject metadata identifier and at least one extension identifier; and
executing, by the metadata search engine, the at least one metadata analysis command to perform the user-defined function over at least a portion of subject metadata that corresponds to the subject metadata identifier.

14. The computer readable medium of claim 13, further comprising instructions which, when stored in memory and executed by the one or more processors causes the one or more processors to perform acts of:
collecting multiple instances of the subject metadata from metadata stored in a storage pool; and
generating a metadata results list derived from the subject metadata.

15. The computer readable medium of claim 14, wherein accessing the subject metadata comprises apportioning the subject metadata into one or more batches accessible by respective computing nodes.

16. The computer readable medium of claim 15, wherein the batches are apportioned based at least in part on at least one of, a number of metadata items, or a metadata size.

17. The computer readable medium of claim 14, wherein generating the metadata results list comprises reducing two or more sets of the subject metadata based at least in part on a second user-defined function corresponding to a second metadata search extension module.

18. The computer readable medium of claim 17, wherein the second user-defined function is a reduce function.

19. A system comprising:
a storage medium having stored thereon a sequence of instructions; and
one or more processors that execute the instructions to cause the one or more processors to perform a set of acts, the acts comprising,
identifying a distributed storage system comprising a plurality of computing nodes that independently read and write storage objects comprising distributed metadata that describes information stored in a plurality of storage devices of the storage system;
installing a metadata search engine on at least one of the one or more computing nodes, wherein the metadata search engine has an extension executor to accept an extension module that facilitates execution of at least one additional capability that extends capabilities provided by the metadata search engine;
receiving at least one metadata search extension module identified by a respective extension identifier, the metadata search extension module comprising at least a portion of user-defined computer programming code that, when executed by the metadata search engine, performs a user-defined function based on one or more metadata analysis commands;
receiving at least one metadata analysis command of the one or more metadata analysis commands, the at least one metadata analysis command comprising at least one subject metadata identifier and at least one extension identifier; and
executing, by the metadata search engine, the at least one metadata analysis command to perform the user-defined function over at least a portion of subject metadata that corresponds to the subject metadata identifier.

20. The system of claim 19, wherein the at least one additional capability comprises an ability to process a query.
